(19) United States
(12) Patent Application Publication
(10) Pub. No.: US 2011/0025725 A1
(43) Pub. Date: Feb. 3, 2011

(54) BACKLIGHT UNIT AND CONTROL METHOD FOR THE SAME

(76) Inventor: Hendrikus Groot Hulze, Eindhoven (NL)

Correspondence Address: DLA PIPER LLP (US), 2000 UNIVERSITY AVENUE, EAST PALO ALTO, CA, 94303, US

(21) Appl. No.: 12/836,812

(22) Filed: Jul. 15, 2010

(30) Foreign Application Priority Data
Jul. 15, 2009 (EP) 09165578.7

(51) Int. Cl. G09G 5/10; G09G 3/36

(52) U.S. Cl. 345/690; 345/102

(57) ABSTRACT

A backlight unit for a display device and a control method for the same is presented. The backlight unit comprises: a plurality of light source units arranged in a matrix form; a light source controller adapted to supply a control signal for controlling a brightness of the light source units; and a plurality of light source drive units adapted to supply different driving signals to different light source units based on the control signal. The control signal is generated based on optical crosstalk between neighboring light source units.

The present invention relates to a backlight unit and control method for the same, and more particularly to a back light dimming backlight unit and control method thereof for use in a flat panel display device.

A flat panel display device, such as a liquid crystal display (LCD), typically employ backlight units or assemblies for illuminating or lighting up the LCD from the rear surface thereof. It is known to adjust or control the brightness of a backlight, by adjusting or controlling a controller device for the backlight, in order to obtain improved display quality. Further, dimming of the backlight is known technique for saving power and improving contrast of a LCD device.

In an LCD device, the maximal light level is defined by the (local) backlight level. Actual observed pixel levels are defined by the transparency of the display pixels, controlled by LC shutters, and the backlight level. These shutters are not ideal and are not able to block all light. As a result, leakage of light is observed as a bluish haze in dark areas, and this is viewing angle dependent. By dimming the backlight, this leakage of light is reduced, thereby increasing the range of the displayable light levels and improving the global contrast of the LCD device. It is also known to use the potentially saved power to boost the light level of bright areas to get a sparkling picture.

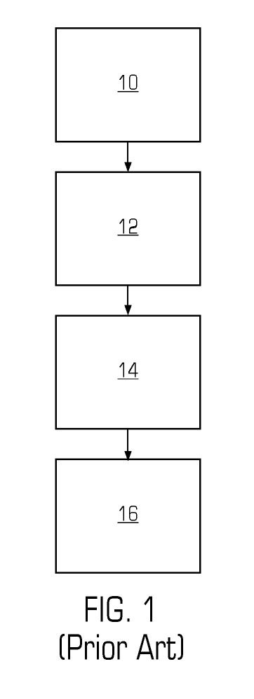

Referring to FIG. 1, a flow diagram of a known backlight dimming algorithm is shown. This algorithm comprises the following four main stages: (i) analysis of video/image content (step 10); (ii) calculation of backlight control parameters (step 12); (iii) calculation of RGB-processing parameters (step 14); and (iv) dynamic RGB gaining of the video/image (step 16).

In step 10 the video/Image content is analysed to determine a light distribution for the backlight. This comprises analysing the video/image content and determining a (local) balance between bright and dark content of the video/image content.

Next, in step 12, backlight control parameters are computed for a best fit of the determined light distribution. These parameters may include response time, gamma, etc., and aim to preserve a smooth response for moving objects in a video, for example.

Continuing to step 14, RGB-processing parameters are calculated to provide an actual light output profile using the optical characteristics of the backlight and the LCD panel.

Finally, in step 16, the local video-data gain is calculated as a function of the light output profile to obtain a preferred luminance level at the front of the display without introducing visible quantization and/or clipping artifacts. This may include gamut mapping (for RGB color dimming).

Simplifications of this known algorithm may be implemented for specific applications having a preferred objective, such as improved power saving or improved picture quality for example. Typically, however, the actual implementation is defined by the properties of the backlight (for example, number of light drivers, position and type of light sources, luminance or color-mode, etc.) and the method used to analyze video/image content.

According to an aspect of the invention, there is provided a backlight unit for a display device comprising: a plurality of light source units arranged in a matrix form; a light source controller adapted to supply a control signal for controlling a brightness of the light source units; and a plurality of light source drive units adapted to supply different driving signals to different light source units based on the control signal, wherein the control signal is generated based on optical crosstalk between neighboring light source units

The control signal may be determined using spatial high pass filtering so as to compensate for a low pass characteristic of optical crosstalk between neighboring light source units.

According to another aspect of the invention, there is provided a control method for a backlight unit comprising a plurality of light source units arranged in a matrix form, wherein the method comprises the steps of; generating a control signal for controlling a brightness of the light source units; and supplying different driving signals to different light source units based on the control signal, wherein the control signal is generated based on optical crosstalk between neighboring light source units.

For a better understanding of the invention, embodiments will now be described, purely by way of example, with reference to the accompanying drawings, in which:

FIG. 1 is a flow diagram of a conventional backlight dimming algorithm;

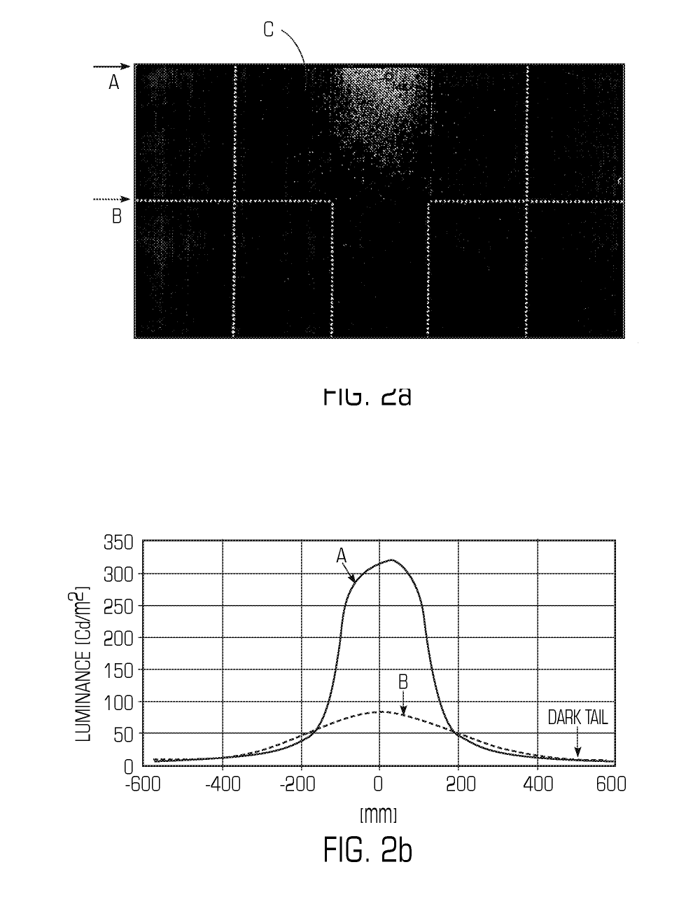

FIG. 2a illustrates a side lit backlight comprising two rows of five adjacent segments;

FIG. 2b shows a luminance profile for the backlight of FIG. 2a;

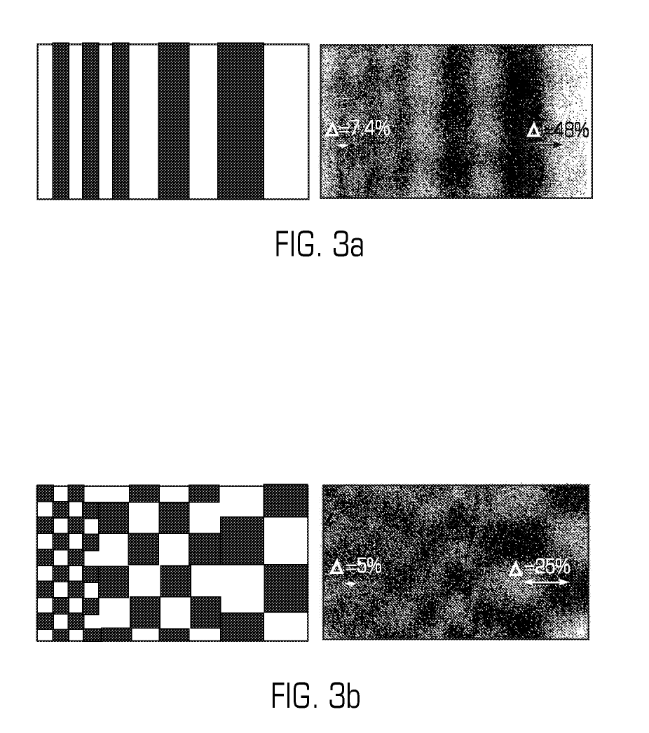

FIGS. 3a and 3b show exemplary control levels and a corresponding resultant backlight profile for a direct lit backlight comprising ten rows of eighteen segments;

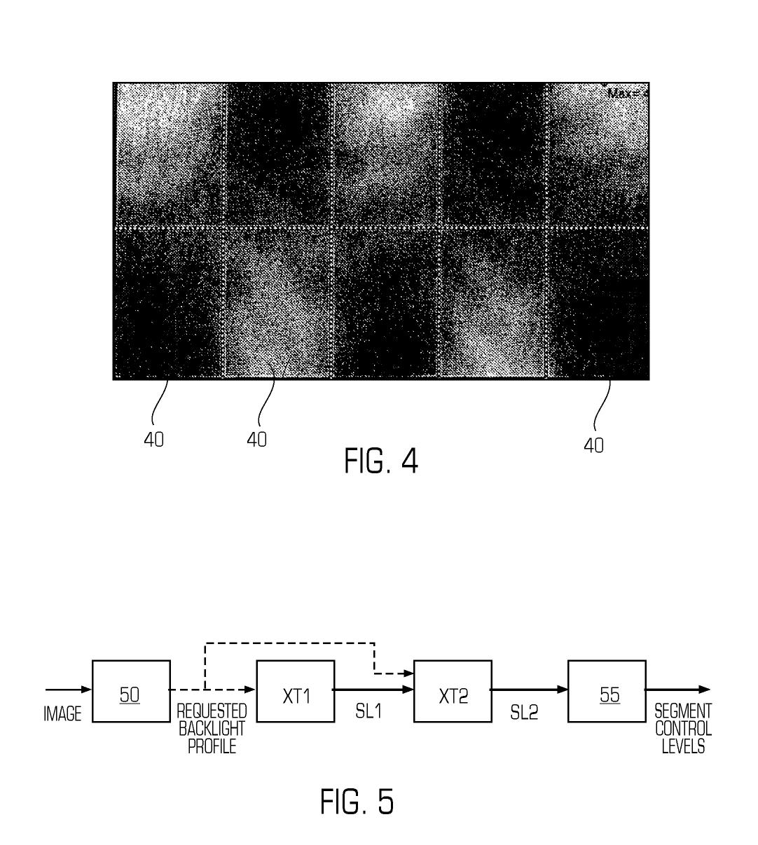

FIG. 4 illustrates a side lit backlight with ten segments controlled in an alternating on/off pattern;

FIG. 5 is a flow diagram of a method for controlling a backlight according to an embodiment;

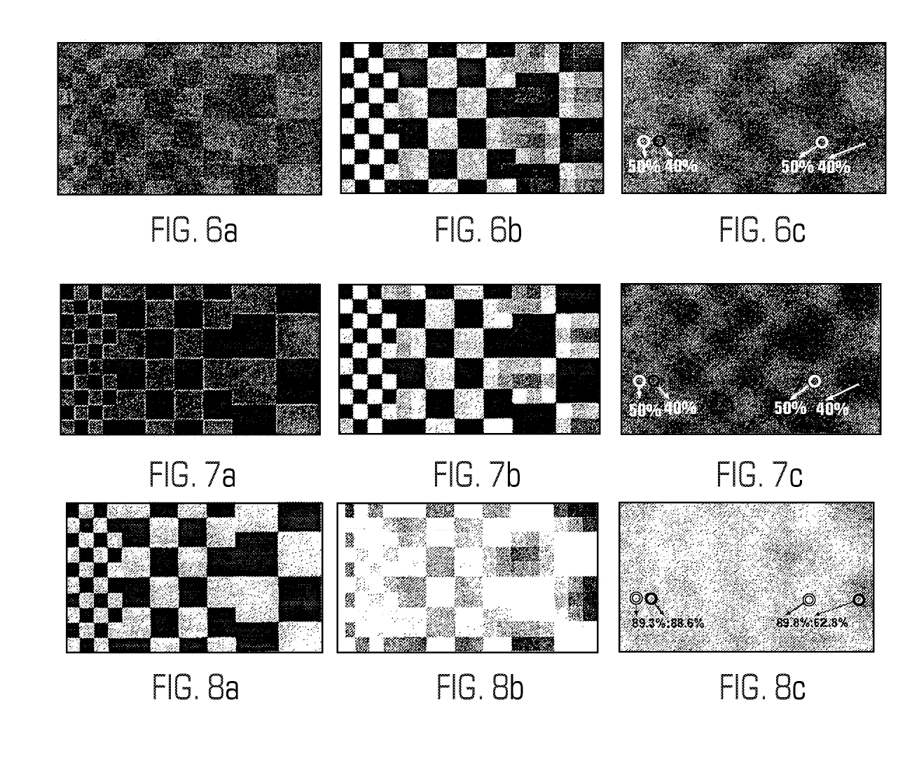

FIGS. 6a-6c show requested levels, corresponding segment driver levels, and a corresponding backlight profile, respectively, for a backlight according to an embodiment;

FIGS. 7a-7c show other requested levels, corresponding segment driver levels, and a corresponding backlight profile, respectively, for a backlight according to an embodiment;

FIGS. 8a-8c show other requested levels, corresponding segment driver levels, and a corresponding backlight profile, respectively, for a backlight according to an embodiment;

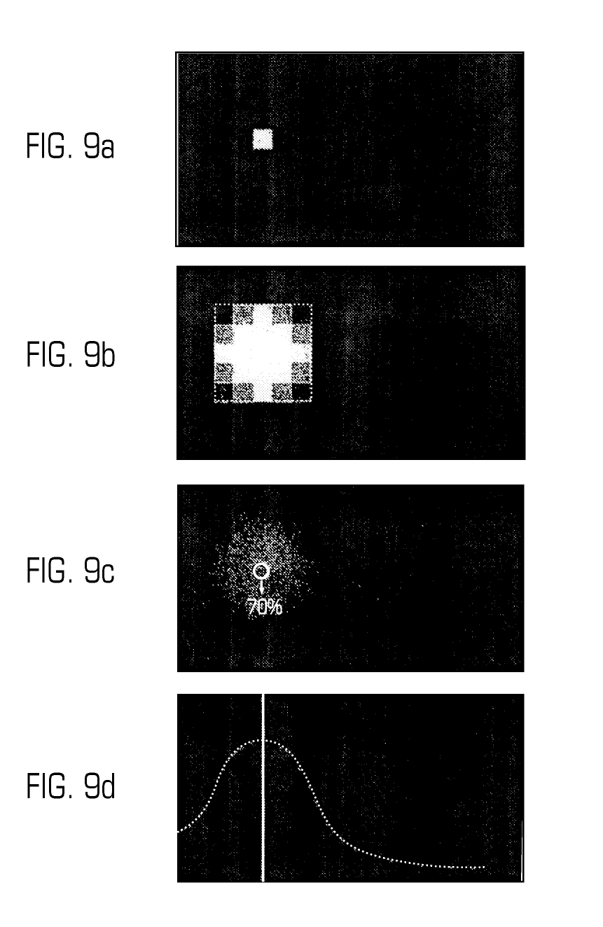

FIG. 9 illustrates a worst case example of a single bright segment being requested;

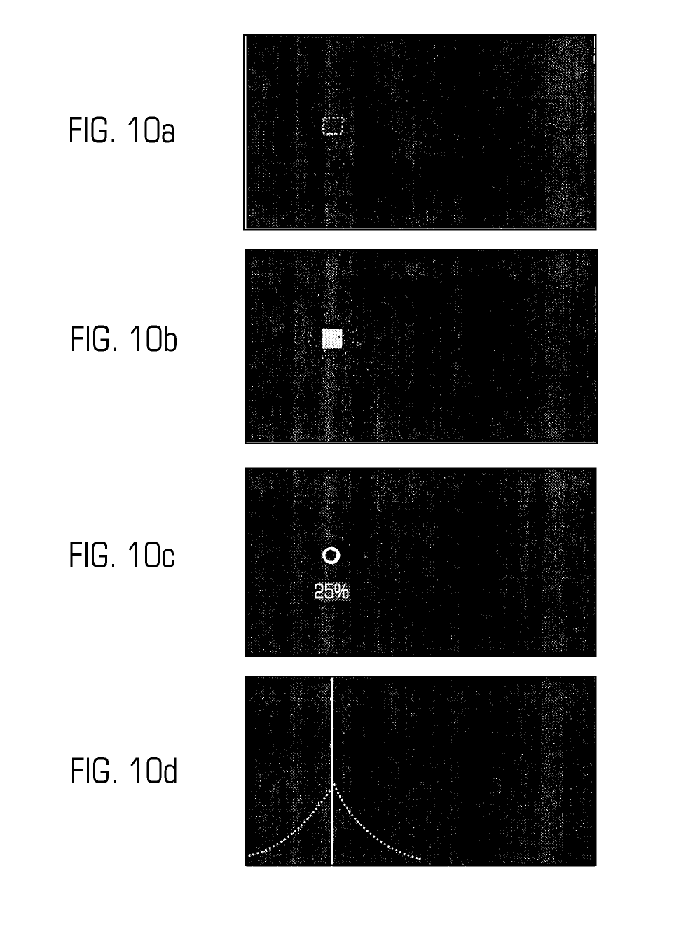

FIG. 10 illustrates an example wherein a single segment of 25% brightness is requested;

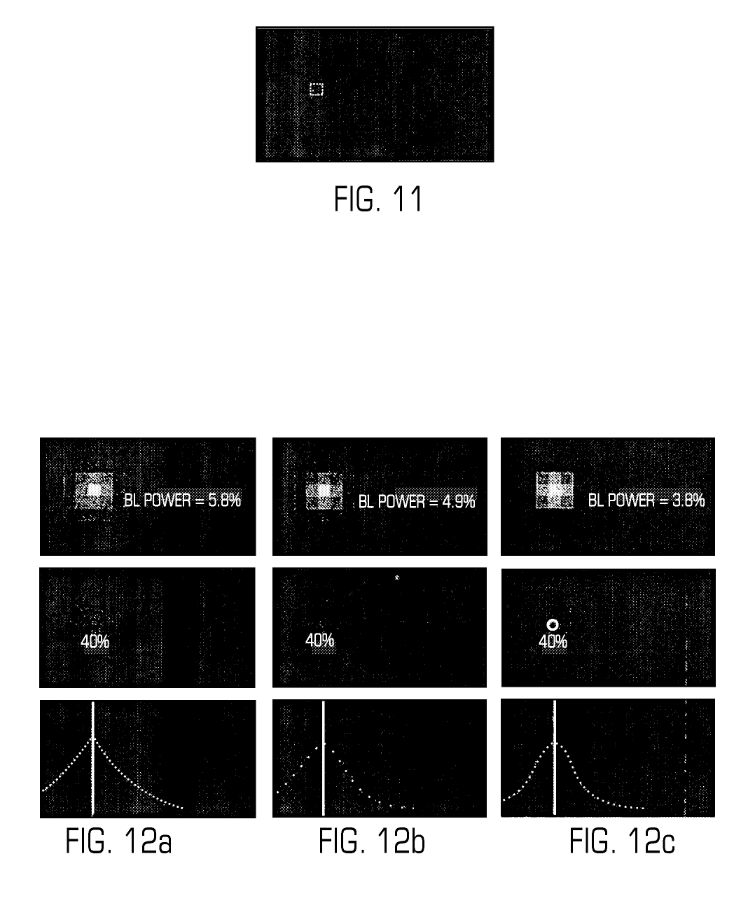

FIG. 11 illustrates an example wherein a single segment of 40% brightness is requested;

FIGS. 12a-12c show corresponding driver levels, backlight profile and gamma cross-section for the example of FIG. 11 and kernel sizes of 7×7, 5×5 and 3×3, respectively;

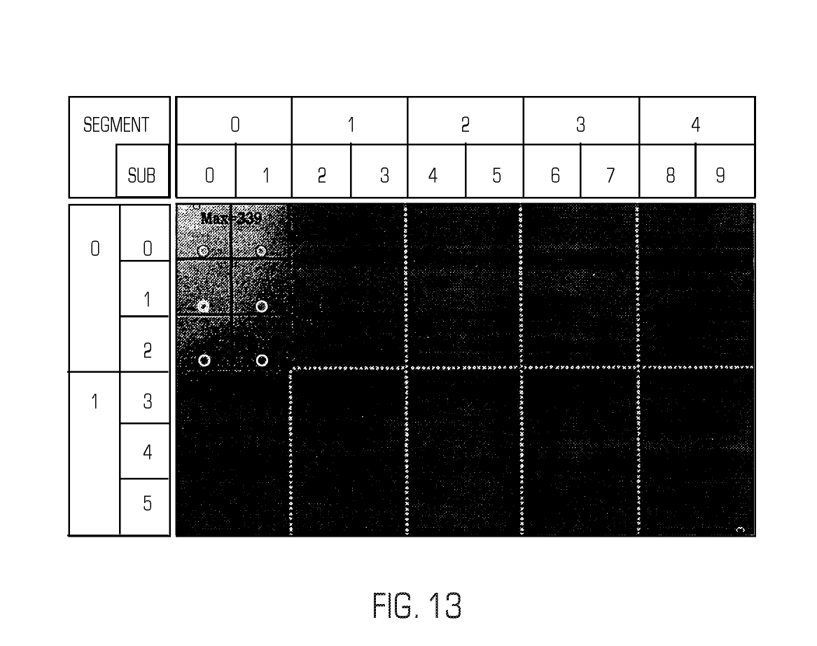

FIG. 13 illustrates a backlight according to an embodiment, wherein each segment is split into six (2×3) sub-segments;

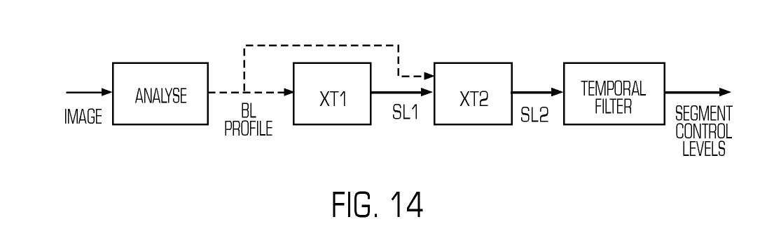

FIG. 14 is a flow diagram of a method for controlling a backlight according to an alternative embodiment with subsegments;

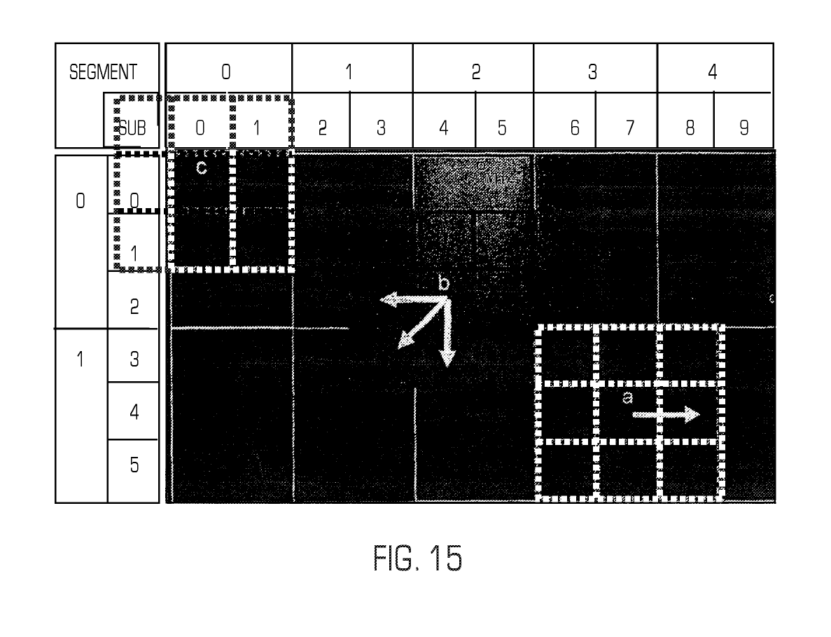

FIG. 15 illustrates the concept of using light from sub-segments of neighboring segments according to an embodiment;

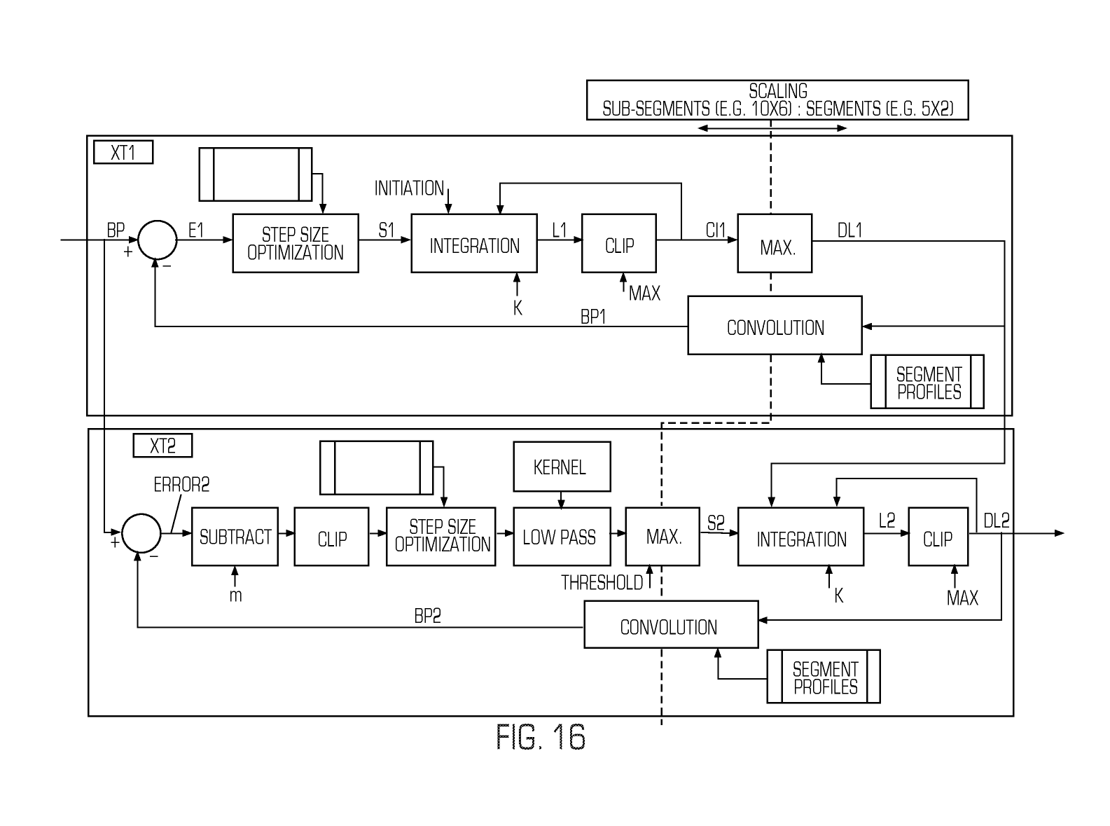

FIG. 16 is a block diagram of first and second optical crosstalk compensation stages according to an embodiment; and

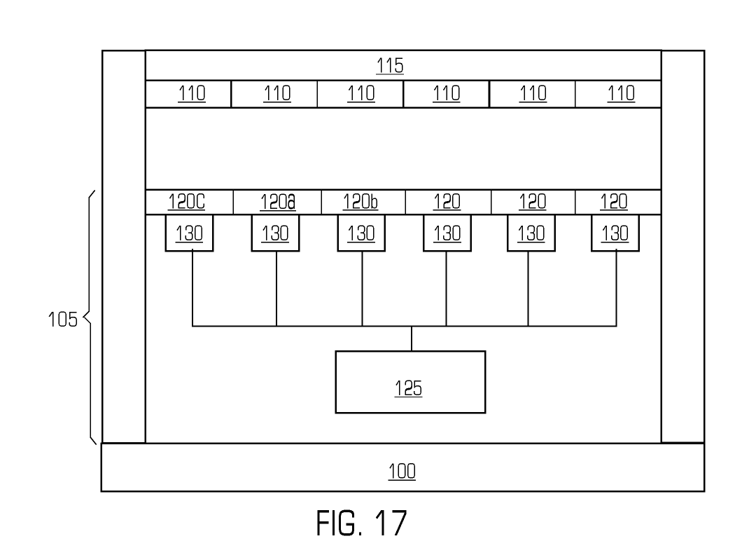

FIG. 17 is a schematic cross section of a display device according to an embodiment.

A backlight unit may be segmented and comprise a plurality of light source units, or segments, arranged in a matrix form, and a light source controller outputting a (dimming) signal to control a brightness of the segments. The number of segments is defined by the number of independently controlled light sources, typically strings of LEDs.

The number of segments per unit area may be otherwise referred to as the resolution of the backlight unit.

Restricted backlight resolution and optical crosstalk between the segments limit possible power savings and cause optical interactions between the segments. Sharper segments (e.g. by providing walls between the light sources) enable deeper local dimming performances, but introduce artifacts like visible rectangular halos and increased sensitivity for tolerances. Thus, segmented backlights present challenges for backlight dimming algorithms. Further, for side lit light source, it is difficult to ensure a homogenous backlight even without local dimming.

Referring to FIG. 2a, there is shown a side lit backlight comprising two rows of five adjacent segments (i.e. 2×5 segments), wherein only the upper centre segment is turned on. Unless otherwise stated, references to a backlight unit refer to this type of side lit backlight. This backlight comprises one hundred and sixty (160) high-power white LEDs mounted at an upper or lower edge of the panel and divided into ten (10) strings/rows.

It is known that the light distribution of the segments has significant impact on the performance of a dimming algorithm.

Turning to FIG. 2b, a luminance profile for the backlight of FIG. 2a is shown. The solid line shows the variation of luminance against horizontal displacement along upper edge of the backlight (indicated by the arrow labeled “A”). The dashed line shows the variation of luminance against horizontal displacement along the centre of the backlight (indicated by the arrow labeled “B”).

Aspects of the luminance profile for the backlight of FIG. 2 can be observed, notably:

(i) It is asymmetrical in shape—the light is not concentrated in the centre.

(ii) There is negligible optical crosstalk with neighboring segments at the edges of the panel.

(iii) There is significant horizontal crosstalk at the centre of the backlight.

(iv) There is a high level of luminance variation within the upper centre segment (indicated by the solid rectangle labeled “C”).

The above identified properties suggest less than ideal luminance profiles when compared to luminance profiles of a direct lit solution. Hence a more complex algorithm may be required.

Nonetheless, some positive aspects of the luminance profile for the backlight of FIG. 2a are noted, namely:

(i) The is limited vertical crosstalk between the upper and lower rows of the backlight;

(ii) The profile as short “tails”, meaning the areas far away from the upper centre segment (i.e. spaced apart by at least one segment) experience negligible illumination from the lit segment.

Three aspects related to picture quality properties are affected by the segmentation profiles, namely: halo effect; dynamic contrast range; and clipping artifacts. These will now be discussed separately in more detail.

Halo Effect

Around a bright object on a dark background, a halo appears if local dimming is applied. This is caused by local light leakage of the backlight panel near the position of the bright object, while the leakage is reduced at the positions with dimmed segments. Thus, it is actually the non-“improved” black level around the bright object that is the visual artifact here. A known technique to reduce a halo effect is to apply spatial low pass filtering on the backlight control signals. However, this reduces the contrast improvement and power saving performances.

Also, the optical crosstalk between neighboring segments has a big impact on the visibility of a halo. A sharp segmentation also means sharp and “discrete” halos, which is more likely to be observed by a viewer. However, sharp segmentation improves on power saving performance.

Halos of moving objects are problematic since the halo moves irregularly and modulates in size. This effect is more pronounced for large and sharp segments. A known technique to reduce such irregularities employs a temporal filter on the backlight control levels, but this is not ideal if the motion of the moving object is fast or there is a scene change in the video.

An extra problem associated with halos for a side lit backlight is the fact that the halos mostly appear at the side of the panel were the optical crosstalk is lowest and the light level higher (for a single segment). Here, the halo may appear out of place with the bright object and not around it.

Dynamic Contrast Range and Brightness

Contrast is the ratio between darkest and brightest level. For a LCD panel with dimming backlight, the maximum observed contrast (in a dark room) is the contrast of the LC-shutter (transparency range) multiplied by the dimming range. In the temporal domain, this can be “unlimited” by turning of the backlight. In the spatial (2D) domain, the contrast range is dependent on the optical crosstalk between segments of the backlight. In essence, the light distribution of the segments acts as a kind of low pass flittering of the control levels. Also, this optical crosstalk between segments may result in light shortage for segments if neighboring segments are dimmed. Hence, a dimming algorithm needs to be aware of these limitations. Dimming should preferably not result in a picture with more black but without sparkling details.

Modulation is the difference between two levels relative to the nominal level (100% white). Turning to FIGS. 3a and 3b, it is observed that the resolution of a test pattern (eg. drive levels of a backlight) has an impact on the observed light modulation of the backlight.

The left image of FIG. 3a shows the control levels of the segments of direct lit backlight comprising ten rows of eighteen segments (i.e. 10×18 segments). Specifically, the test pattern comprises an on-off pattern varying in 1-Dimension (1D) (horizontally) to create alternately spaced black and white vertical bars increasing in width from left to right. The right image of FIG. 3a shows the resultant backlight profile for the backlight, thereby illustrating the effective modulation depth (defined as local maximum minus local minimum relative to nominal white).

The left image of FIG. 3b shows the test pattern comprising a on-off pattern varying in 2-Dimensions (2D) (horizontally and vertically) to create alternately spaced black and white squares increasing in size from left to right. The right image of FIG. 3b shows the resultant backlight profile for the backlight, thereby illustrating the effective modulation depth.

From FIG. 3b is seen that the modulation at the left side is 5%, whereas at the right side the effective modulation is increased up to 25%. This is due to the lower spatial frequency of the test pattern at the right side.

If the same frequency is applied in only one direction, it is seen from FIG. 3a that the modulation is improved, by ×1.4, to 7.4% (at the left side) and 48% (at the right side).

Referring now to FIG. 4, there is shown a side lit backlight with ten (5×2) segments 40 in an alternating on/off pattern. Here, it is seen that the horizontal optical crosstalk varies with vertical position. Since the largest modulation between the segments is at the top or bottom edges of the panel, less crosstalk compensation is required at these edges.

Since the luminance profile of a segment is not flat (see FIG. 2b) the luminance level of a segment may change if the brightest object in a segment moves within the segment.

In conclusion, a preferred control level of a backlight is proportional to the required light level and the ratio between local light output and control level. Each segment also illuminates its neighbors (due to optical crosstalk). The segment control levels preferably needs to be compensated for this optical crosstalk, taking into account the limited backlight control range (no negative light, and limited or no boosting range). Furthermore, for large (side-lit) segments, the problem is more complex since even within a segment the light levels fluctuate. The use of a point spread function (used in known local dimming techniques) has been shown to be unsuitable here.

In practical implementations, dimming of the backlight will typically introduce some light shortage at some positions of the picture, even with proper crosstalk compensation. To prevent any light shortage at all, each single subpixel at 100% would prevent any of the segments to dim since all segments have some contribution in the backlight luminosity at every position.

A light shortage can either be accepted, or compensated for by extra gaining of the video. However, the peak brightness is still reduced and a soft clipper is required to preserve detail in relative bright areas. The multi scale approach in embodiments helps to quantify the observed clipping artifact so dimming can be reduced if applicable.

Embodiments thus focus on a method of a proper calculation of the backlight control parameters as a function of the requested backlight profile generated by a picture analyzer. The calculations are executed in the linear light domain.

Embodiments implement crosstalk compensation is to make sure the actual backlight profile is as close as possible to a requested backlight profile. This is achieved by compensation of the optical crosstalk between segments by emphasizing the differences of the control levels. In other words, crosstalk correction uses spatial high pass filtering to compensate for the low pass characteristic (optical crosstalk) of the segments in a backlight.

The “crosstalk high pass filter” can be implemented in a recursive way to make sure that clipping of the control levels (0%-100% or 0%-boosting level) is handled properly. Also, a non-linearity can be intentionally introduced to make sure that dark segments which are too bright are preferred over bright segments which are too dark. This is to prevent more pixels clipping than defined by the settings of the picture analyzer. An optimal modulation of the backlight may then be achieved without having (too much) light shortage at any position.

Turning to FIG. 5, there is illustrated a method of controlling a backlight according to an embodiment. From this it will be appreciated the crosstalk compensation process comprises two stages (XT1 and XT2).

Firstly, an image is provided to an image analyzer and the image is analyzed (step 50) at a segment, or sub-segment resolution in the multiscale approach, to determine a requested backlight profile. Preferably, the image provided for the analysis step 50 is downsampled to reduced resolution that preserves image details. Next, the requested backlight profile is passed to crosstalk stage 1 (XT1) in which symmetrical high pass filtering is undertaken. Even if a segment is driven at full power it is possible that not enough light is generated at that position. In that case, the segment levels SL1 are passed to crosstalk stage 2 (XT2) which increases the levels of neighboring segments, with respect of the dimmed level, to produced new segment levels SL2 which get enough light in the segment. Thus, to overcome artifacts caused by clipping of the control levels, both crosstalk stages XT1 and XT2 are executed in a recursive way.

For the functionality of the crosstalk stage XT2 it is not relevant what kind of preprocessing has been done in crosstalk stage XT1. In particular, it is not necessary to apply a high pass filtering in crosstalk stage XT1 in order to achieve the advantageous effects of crosstalk stage XT2. Any processing in crosstalk stage XT1 can be combined with crosstalk stage XT2.

The segments levels undergo temporal filtering in step 55 to generate segment control levels.

Three examples are illustrated in FIGS. 6, 7 and 8, These examples are simulations of a realistic (proto-typed) direct lit backlight with 18×10 segments.

Referring to FIG. 6a, the requested levels are shown, wherein the levels are grey (40%) and grey (50%). FIG. 6b shows the corresponding segment driver levels and FIG. 6c shows the corresponding backlight profile. It is seen that the requested backlight modulation can be made by the backlight, and for high spatial frequencies the control levels are no clipping (see left side of FIG. 6b).

Referring to FIG. 7a, requested levels are shown, wherein the levels are black and grey (50%). FIG. 7b shows the corresponding segment driver levels and FIG. 7c shows the corresponding backlight profile. It is seen that the requested dark levels in FIG. 7a are darker then in FIG. 6, whereas the bright levels are equal. Simple high pass filtering would result in “ultra black” (<0%) control levels. Since negative light is physically impossible the “ultra black” levels are clipped to black (0%).

Due to the recursive implementation, the brighter segments are aware of the clipping of the dark segments and are reduced in amplitude. This prevents too much asymmetrical clipping or DC-shift. As a result, bright overshoots of the backlight profile are prevented at the right side of the backlight profile in FIG. 7c.

Referring to FIG. 8a, requested levels are shown, wherein the levels are black and white (90%). FIG. 8b shows the corresponding segment driver levels and FIG. 8c shows the corresponding backlight profile.

Clipping of the control levels does not only apply for “ultra” black levels. The boosting range of the segments will be limited by the power and temperature limitation of the light sources. In most applications the maximum control level will be the level required for the nominal (non-dimmed) light level (100%). If bright segments are clipped due to overshoot in crosstalk stage 1 XT1, the backlight luminosity at that position will be too low.

The filter construction in Stage 2 “grows” those light levels at the backlight by boosting (or “growing” by reducing the dimming) of the neighboring segments of the bright clipped segments. Consequently, it is seen that most segments in the example of FIG. 8 are hardly dimmed. The spatial resolution of the requested backlight profile is too high with respect to the segmentation of the backlight.

The amount of “growing” of the neighbors in crosstalk level 2 XT2, is controlled by a spatial low pass filter. This will provide a circular backlight profile as response on an isolated segment. Circular shaped halos are less annoying since they are more natural (soft focus).

Turning now to FIG. 9, a “worst case” example of a single bright segment is shown. FIG. 9a shows the requested level of a single segment is white (100%). FIG. 9b shows the corresponding segment driver levels, and FIG. 9c shows that corresponding backlight profile achieving a luminosity level of 70%. This is observed as 85% due to gamma. FIG. 9d shows the cross section of FIG. 9c in the non-liner (gamma) domain. The kernel of the low pass filter limits the maximal achieved brightness level. It will be seen from FIG. 9b that the kernel size is 7×7. Thus, if a higher light level (>70%) is required, the kernel should be larger. The optical crosstalk between the segments influences the result of the low pass filter. The more optical crosstalk the segments have the larger the required kernel size is. The kernel size determines how many neighboring segments can help to realize the light level.

In the second example in FIG. 10, the requested backlight level is reduced to 25%. FIG. 10a shows the requested level of a single segment is 25%). FIG. 9b shows the corresponding segment driver levels, and FIG. 9c shows that corresponding backlight profile achieving a luminosity level of 25% (observed as 50% due to gamma). FIG. 10d shows the cross section of FIG. 10c in the non-liner (gamma) domain. From this, it is seen that the control levels still have a circular shaped distribution, but they are smaller then 25% of the control levels FIG. 9b. In other words, the response is not a linear function of the input. This is because the levels are proportional to local light shortage of the segment if the segment is turned on completely, and not proportional to the requested level as it would be in a “normal” filter configuration. This way, the amplitude of the circular halo is minimized, by maximizing the amount of light in the centre in the halo. Hence, the cross section of the dark halo in FIG. 10d is more pointed with respect to the bright halo of FIG. 9d. The shape is therefore amplitude dependent, and it is relevant for optimizing power saving performance and reducing the visibility of the halo.

In addition to the amplitude dependent halo shape it is possible to adjust the effective kernel size of the low pass filter, as function of the amount of light required. Using a larger kernel for bright segments enables a high light output for isolated bright segments, as has been seen from FIGS. 9 and 10.

FIG. 11 shows an example where the requested level of a single segment is grey (40%). FIGS. 12a to 12c then show the corresponding segment driver levels, backlight profile achieving a luminosity level of 40%, and cross section in the non-liner (gamma) domain for kernel sizes of 7×7, 5×5, and 3×3, respectively.

It is seen that a kernel with a smaller spatial response for lower required backlight segments is an improvement on power saving. Nonetheless, a minimum size of 3×3 may be required to preserve a circular response.

The second stage is a recursive one. In principle the loop is repeated until all sub-segments are at least as bright, within a predetermined threshold range, as requested for. The predetermined threshold range may be enlarged as the number of iterations increases so as to prevent all segments from growing ad infinitum. The threshold range (30% error in the examples above) helps to preserve the circular response of the low pass filter. Otherwise, all segments within the kernel would reach their maximum level, making the backlight profile rectangular shaped.

Kernel coefficients control the “error spread function”. Consequently, this affects the speed (integration step per iteration) at which neighboring segments grow. In combination with an iteration counter, this speed controls the maximum amount of growing. A preferred principle here is to allow boosting of neighboring segments to reduce clipping artifacts, but except more picture clipping if more boosting (less power saving) is required.

Multi-Scale Approach with Help of Sub-Segments

The first step to improve on dimming performance for poorly segmented backlights is to analyze the image in a higher resolution than the segment resolution of the backlight. For this, the image picture is divided into sub-segments. In a typical application, this analyzing is based on histograms, so generation of the histograms is executed at a sub segment resolution. Hence, for each backlight segment, multiple histograms are generated. This extra resolution helps in four ways:

(i) Awareness of the local segment profile level at the position (within the segment) light is required.

(ii) Awareness of the position with the highest light shortage if the segment it self can not generate enough light.

(iii) Improved response on moving objects.

(iv) The higher resolution of the analysis also holds smaller area per histogram, thereby providing improved clipping artifact quantification since clipping artifacts are worse when the pixels are clustered instead of being spread over a weight area.

The required sub segmentation factor is preferably at least two in both the horizontal and vertical direction. In other words, a segment is preferably divided into at least four equally sized sub-segments, with the vertical size of the segment being divided into at least two sub-segments and the horizontal size of the segment being divided into at least two sub-segments. In embodiments, the vertical sub segment resolution may even be tripled to cater for the large brightness variation of the segment profile in the vertical direction.

When the horizontal sub-segment resolution is double that of the segment resolution, and the vertical sub-segment resolution is triple that of the segment resolution, a segment corresponds to three rows of two side by side sub-segments (i.e. a 2×3 arrangement), as shown in FIG. 13. From FIG. 13, it will be appreciated that the “required backlight profile” generated by the image analysis with histograms is then available at resolution which is six (2×3) times higher than the segment resolution.

A control level per segment is then retrieved using novell downscaling. This downscaling function of the algorithm ensures enough light for all sub segments. For all sub segments a “virtual” control level for the segment is calculated for achieving the requested level at the position of the sub segment. Each segment is then controlled according its highest “virtual” sub segment control level. A lower level would introduce picture clipping as a result of the unexpected high video gain. Generally, this is the sub-segment with the highest required level multiplied by a sub segment efficacy factor.

For each sub segment, the efficacy is proportional to the relative light level of the segment profile at the position of the segment. By using the lowest level per sub-segment to determine efficacy, indicated by the circles in FIG. 13, it is ensured that there is enough light in the complete sub segment area.

Like in the non-subsegmented version of the algorithm, cross-talk correction is implemented to improve the dimming performances.

FIG. 14 illustrates a method of crosstalk compensation according to another embodiment

The downscaling of the requested levels at subsegment resolution is executed by the crosstalk stage 1 XT1 to obtain a control level per segment. The segment control levels are provided to the backlight drivers and are also the input for the Control RGB Processing stage of the dimming algorithm.

The crosstalk compensation is executed in two stages by a recursive loop. As for any recursive system, an “error” is required for the feedback. Here, this is the difference between the “required” backlight levels, and the actual result of “current” control levels. In each run of the recursive loop, the backlight profile is calculated at sub-segment resolution. This is the result of the convolution of the current segment control levels (at the lower segment resolution) with the segment profiles (at sub-segment resolution). In order to obtain the control levels for next run, the error at sub segment resolution is downscaled to segment resolution.

In essence, the crosstalk compensation here is the same as the embodiment without subsegments detailed previously. In the first crosstalk stage XT1, the feedback is based on the error at sub-segment resolution. Each segment is dimmed or boosted until the most critical sub-segment has enough light. In that case, the other sub-segments will be known to have the same or more light.

When the recursive loop is settled, each of the segments is either OK, too dark or too bright. In case of being too bright when a segment is already dimmed to minimal, light must be coming from neighboring segments. If (at least part of) the segment is too dark and the segment is at a maximum level, extra light can be provided by neighboring segments at the cost of power saving performances. Such adjustments are provided by the second crosstalk stage XT2.

Thus, in the second crosstalk stage XT2, light is “borrowed” from one or more neighboring segments if the segment is already at a maximum and still not bright enough. The position of the light shortage (defined by the sub-segment) effects what neighbor segment will “grow” (for example, be boosted or dimmed less). In order to obtain this effect, the error (again at sub-segment resolution) is clipped to levels below zero, preserving info on light shortage only. Then with a spatial low pass filter with a small kernel size (typically 3×3) the light shortage of all sub-segments are distributed to neighboring sub-segments. The purpose of the small kernel is to make sure that only close sub-segments of the neighboring segments are affected.

This is illustrated by the examples in FIG. 15.

Where sub-segment a(7,4) is located at the middle of the right side of segment (3,1), the kernel will only spread the error to the right neighboring segment (4,1).

For sub-segment b(4,2) in part of segment (2,0), three neighboring segments are reached by the kernel.

For sub-segments at the corners of the backlight (e.g. c(0,0)) the kernel will not reach any other segment, which is not problematic since at this position there is hardly any optical crosstalk to neighboring segments. I

It will be appreciated that the corner sub-segments are almost completely illuminated by the segment itself. All other sub-segments do have the risk of a light shortage and need to be able to borrow light from other segments. So if the number of sub-segments per segment is larger also the kernel of the error spread filter should be enlarged. If the multi scale approach is used for backlights with already small segments it may still be required to use larger or adaptive kernel sizes. As a result, the growing levels can be asymmetrical.

Changes with respect to conventional dimming algorithms (without the definition of sub-segments) may be implemented in the crosstalk compensation function of a basic dimming algorithm such as that shown in FIG. 2. Here, the sub-segment resolution is downscaled to the same resolution as the segment resolution.

Turning now to FIG. 16, a block diagram showing the two crosstalk compensation stages is shown.

The block diagram shows two recursive loops. An overall “manager” (not drawn in the picture) starts the loops when the input “required backlight profile” (BP) is updated. When the picture analyzer of a previous stage of a dimming algorithm is finished, a requested backlight profile BP is known and provided to the first crosstalk stage XT1 as an input. This input BP is an array of light levels at sub-segment resolution and defines the preferred minimal light levels for each sub-segment. It is used in both stages to define the error in the loop.

Crosstalk Stage 1 XT1

For the first iteration, the loop is initiated by calculation of a best guess of the virtual drive levels (Clipped Levels 1) CL1. The simplest best guess is to use the requested levels. An improvement is to compensate these levels for the affectivity of the segment at that sub-segment position. This is the same function as “Step size optimization” used to calculate integration S1, as a function of Error E1. The used scalar array (Error scalars) represents the efficacy of the sub segments. It is defined by the ratio of segment control level and the (lowest) light levels of the segment profile at the position of the sub-segments (see FIG. 13).

An alternative to initiate the loop is to use the final result of a previous run. Typically, this reduces the number of iterations, since on a frame by frame base the difference will often be small. But the worst case number of iterations per run is enlarged, probably at a scene change. A scene change detector can therefore help here to control the initiation of the loop.

Convolution with Segment Profiles

In each run of the loop, the effect of the optical crosstalk on the drive levels is calculated to determine the step size for all segments, the step sizes being the change of the drive levels of next run. For this, the backlight profile is calculated at subsegment resolution by summation of the influences for all the segments. Hence this is a convolution of the segment profiles with the Drive Level values DL1 of the current iteration. This convolution acts as an up-scaler.

A segment profile is the backlight profile of a segment at sub-segment resolution if only that segment is turned on.

The profiles can be stored in a 3D-array as a set of “bitmaps”, one for each segment. Data reduction is possible by making use of the horizontal and vertical symmetry of the segments. For example, the profile top left segment may be a flipped version of the top right one.

Segment profiles are also used to calculate the gain-map used in the RGB-video processing part of the dimming algorithm. Typically, the required resolution for the gain-map is much higher since the gain for each pixel needs to be defined. Therefore, the cross-talk segment profiles can be obtained by sub-sampling these higher resolution profiles.

A way to sub sample is to ascertain the light level at the centre position of the sub-segment. In this particular case, it is preferred to use the lowest light level of the profile within the area of the sub-segment, thereby ensuring a worst case result from the error comparator.

Error Comparator and Scalar Function

The basic concept of a regulator with feedback is to obtain an error by subtracting the measured level from the requested control level. In this particular case, the measured level is the convolution result, representing the actual backlight level. Any non-idealistic behavior of the backlight, like temperature effects, is not taken into account.

The error provides the initial information about how much (S1) each segments should be boosted or dimmed. Here, a shortage of light is represented as a positive error.

Step Size Optimizer

The size of the step per (sub)segment is proportional to the error and a loop gain control parameter (k). The total loop gain is also influenced by the segment profiles.

Example Case—Few Segments and Sub-Segmentation

To match the loop gain for all sub segments, error of each sub segment may be multiplied with each unique error scalar. The scalar represents the sub segment efficacy factor and is defined by the light level at the position of the sub segment when only the segment the sub-segment is part of is turned on (see FIG. 13). The subsegment error scalars can be stored in a 2D-array, but this array is in fact a subset of the light profiles, as used for the convolution.

Example Case—Many Segments and No Sub-Segmentation

For the case of a large number of segments (typically with no sub-segmentation), it is preferable to minimize the number of iterations required for the loop to settle. Knowing that the result (change of the backlight profile) of the steps will be low-passed, it is useful to pre-correct for this in advance by applying a high pass filter on the error. It is not required to be highly accurate since the mismatch is simply compensated for by the feedback of “next” error. Use a small kernel (3×3) involving only the direct neighbors is therefore appropriate. Further, it is preferred not to exaggerate the high pass filtering because that may compromise the loop stability. For this reason, small negative coefficients (for example, −50% of the actual optical crosstalk) may be implemented and help to ensure a DC free response.

Integration Step by Step

The drive levels (L1) are defined by an integrator. During each iteration, the previous levels are incremented by the step size S1 multiplied by k to obtain the new levels L1. Preferably, this is repeated until the error, hence step size, is zero or below a predetermined value for all segments. To minimize the number of iterations required for the loop to settle, the first previous drive levels can be initialize with a best guess based on the (settled) result of stage 1 of previous requested backlight profile. Alternatively, the requested levels may be used for initiation.

Due to the limited ranges of the control levels, an additional check may be required to prevent the loop running endlessly if the requested level of a segmented can not be reached due to clipping. Here, if the Clipped Levels 1 CL1 are not changed with respect to the previous run, the loop is stopped. When the loop is stopped, each segment is either clipped to its lowest level when the segment is too bright, or clipped too its maximum level when the segment is too dark or the segment is settled at the light level requested.

For a stable loop, the total loop gain needs to be smaller than 1 by definition. Since for each run all segments are calculated in parallel, the system actually consists of many loops (one per segment), which influence each other heavily. Hence the gain is preferably small (i.e. <<1), to ensure a large margin and hence a stable, non-oscillating, response.

The function of the error scalar function (mentioned in previous section) is to achieve comparable loop gain for all sub segments. This function can be omitted if it is not important to minimize the settling time of the loop.

Clipping Range

As stated before, the control range of the segments is limited. By its very nature, negative light is not possible. Also, some light sources or driver technologies require a minimal drive level (e.g. 10%). On the high level side, the control range is defined by current, and power limitations mostly ensure the temperature is below a destructive limit. It is possible the maximum drive level of a segment is above the drive level required for a homogeneous backlight at its nominal peak white level (i.e. >100%). This is the case by installing more LEDs to this affect.

Even without extra LEDs, the real maximum value is dependent on the actual temperature of the segment at a specific moment in time. Accordingly, the “max” may be dynamically controlled through a temperature sensing arrangement integrated with the LED drivers, for example. If a segment and/or its neighbors are dimmed, the local temperature is reduced so the LED can be boosted to achieve the required light level at the required position. This kind of boosting (in crosstalk stage one XT1) will help to save power since it will prevent or reduce the need to borrow light from a neighboring segment.

The (dynamic) clipping action of the segment levels is integrated in this control loop to ensure the actual backlight profile is calculated to determine the error. It is executed at subsegment resolution to prevent a false stop condition or loop instability.

Max Function to Extract Segment Drive Levels

So far all calculations are executed at sub segment resolution. Since each segment can only be controlled by one level, a downscaling from subsegment resolution to segment resolution is required. In line with the concept of ensuring enough light at all positions, the highest “virtual” subsegment drive level of a segment is selected. A max( ) function for all segments may be implemented to achieve this.

Execution of Crosstalk Stage Two XT2

The settled output DL1 of the first stage XT1 is provided as an initiation input of the loop in the second stage XT2. Like in stage one XT1, the drive levels are changed as function of the difference/error (E2) of the requested backlight profile and the actual convolution result of current drive levels DL2.

The error is manipulated to achieve the specific stage two XT2 properties, which are: compensate for local light shortage by increasing neighbor segments, provide a circular impulse response for natural shaped halos, non-linear impulse response to minimize the halo size.

Applying Implicit Light Offset

In some cases the “ensure enough light” requirement cannot hold without preventing the backlight from dimming, even if the picture is mostly dark. This is typically the case for pictures with a small bright object displayed on a panel with a poorly segmented backlight.

By applying a small offset to the calculated error, the loop is tricked with non existing light. The offset is proportional to the number of runs already executed in crosstalk stage two XT2 (loop index j in the diagram). In this way, even if the actual light level cannot be met, the loop will stop after a while when the offset is larger then the actual light shortage. The light shortage will then only occur if the neighborhood of the segment is very dark. However, this dark neighborhood also makes the shortage of light less visible, since the contrast is already high. A soft clipper in the video gain function should reduce the possible loss of details in the bright areas by applying sufficient headroom and/or a reduced gain.

Light Shortage Only

The main difference of crosstalk stage two XT2 with respect to crosstalk stage one XT1 is the asymmetrical behavior or so called grow mode. The aim is to suppress the dominant error caused by clipping of the drive levels in crosstalk stage one XT1. Only segments with a light shortage are compensated for by using light of neighbor segments. Segments with a light surplus are ignored. In fact, more segments will generate more light as required as a side effect of the light shortage compensation.

The error calculation is configured in such a way that a light shortage is represented by a positive polarity of the error. So to obtain the required asymmetrical behavior all negative error levels are clipped towards zero (0).

Low Pass Error Spread Filter

To make segments aware of the possible light shortage of neighbor segments, the clipped error is divided over an area by a spatial 2D low pas filter. The impulse response is preferably circular in shape since it is responsible for the shape of possible halos.

For the case of a backlight having a small number of segments, the kernel of the filter can be fixed and small. The error spread function responds like a normal linear filter.

In a more sophisticated embodiment the kernel size and/or coefficients are adaptive to the error (light shortage). The higher the light shortage the larger the area reached by the filter (effective kernel size) should be since more segments need to be involved to generate enough light.

The adaptive filter area can be implemented by selecting one kernel out of two or more pre-defined kernels. An alternative more gradual approach is to subtract an offset from a pre-defined kernel and than clip the negative coefficients to zero (0).

In order to prevent the need to redefine the kernel for each subsegment, in each run of the loop as function of the error of the subsegment it is an option to redefine the kernel as function of a loop execution counter (like the virtual light offset). The higher the number of runs, the more light is required, hence the more neighbors should be involved in the growing process.

Max Function for Step Level with Threshold

This function is comparable to the max function applied in the first crosstalk stage XT1. However, it is executed at an earlier stage to minimize the (sub)segment resolution (calculations) for the integration and clip function. The max function at this early stage selects the largest candidate, Step 2=max(SpreadError) of the subsegments of each segment. As a result the largest sub segment error is added to the highest previous sub segment drive level of the segment. They are not the same sub segment by definition. This way it is ensured the required step really takes effect.

To reduce the number of iterations, the selected (max) step size may be clipped to a minimal threshold (e.g. step>=1%). In the configuration of the block diagram negative values are already prevented at an earlier stage in the loop, but zero values need to be preserved. The threshold ensures a minimal integration speed unless it is stopped (step=0).

A small overshoot of the loop is possible when it stops. The maximum overshoot is defined by the threshold and the light profile of the segment. Also in this way the loop counter is better parameter for the “required light shortage” as it used for in the “implicit light offset” and “reduce kernel” features.

Turning now to FIG. 17, there is shown a schematic cross sectional view of a Liquid Crystal Display (LCD) device according to an embodiment of the invention. The LCD device comprises a housing 100 within which a backlight unit 105 is positioned below an array of liquid crystal (LC) cells 110, and a glass 115 panel is positioned above the array of LC cells 110. Each LC cell 110 corresponds to a display pixel, the voltage across which determines the LC cell's transmittance of light. The operation of the display so as to display an image is similar to that of a conventional LCD device and well known to a person skilled in the art of display devices. Accordingly, a detailed description of its operation will be omitted, although a description of the backlight will now be provided.

The backlight unit comprises a plurality of light source units 120 arranged in a matrix form, a light source controller 125, and a plurality of light source drive units 130.

The light source controller 125 is adapted to supply a control signal for controlling a brightness of the light source units 120, and the light source drive units 130 are adapted to supply different driving signals to different light source units 120 based on the control signal. In accordance with the methods described above, the control signal is generated based on optical crosstalk between neighboring light source units.

Here, a requested backlight profile BP representing a target brightness level for each of the plurality of light sources is provided to the controller light source controller 125. The light source controller then generates a control signal according to the requested backlight profile BP and using spatial high pass filtering so as to compensate for a low pass characteristic of optical crosstalk between neighboring light source units 120.

Although not visible in FIG. 17, the LCD device also comprises a feedback unit adapted to detect a parameter (such as temperature) of the light source units 120 and to provide a feedback signal to the controller based on the detected parameter. Based on the feedback signal, the controller modifies the control signal.

In an alternative embodiment, a feedback unit may be adapted to calculate the brightness of the backlight at the position of the subsegments and to provide a feedback signal to the controller based on calculated brightness.

Specifically, if the feedback signal indicates that the detected brightness of a first light source 120a is not within a predetermined range of a target brightness value (defined, for example, by the requested backlight profile), the light source controller modifies the control signal to change the brightness of second 120b and third 120c light source units which are neighbours of the first light source unit 120a.

While specific embodiments have been described herein for purposes of illustration, various modifications will be apparent to a person skilled in the art and may be made without departing from the scope of the invention.

1. A backlight unit for a display device comprising:
a plurality of light source units arranged in a matrix form;
a light source controller adapted to supply a control signal for controlling a brightness of the light source units; and
a plurality of light source drive units adapted to supply different driving signals to different light source units based on the control signal,
wherein the control signal is generated based on optical crosstalk between neighboring light source units;
characterized in that said control signal is determined in at least two steps, wherein in one step the control signal of one or more neighboring light source units is modified using an error spread function to compensate for local light shortage and/or local light surplus of the light source units.

2. The backlight unit of claim 1, wherein the control signal is determined by a histogram-based video-data analysis, using a higher spatial resolution than the light source units resolution.

3. The backlight of claim 2, wherein the control signal is determined using spatial high pass filtering so as to compensate for a low pass characteristic of optical crosstalk between neighboring light source units.

4. The backlight unit of claim 3, wherein the control signal is generated according to a requested backlight lighting profile for the backlight, the requested backlight profile representing a target brightness level for each of the plurality of light sources.

5. The backlight unit of claim 4, wherein the control signal is generated according to a comparison of the brightness of one or more subsegments of the light source units with the backlight lighting profile.

6. The backlight unit of claim 5, wherein the control signal is generated according to a comparison of the brightness of one or more subsegments of different light source units using an error spread function.

7. The backlight unit of claim 6, further comprising a driver feedback unit adapted to calculate the brightness of the backlight at the position of the subsegments and to provide a feedback signal to the controller based on calculated brightness,
and wherein the controller is adapted to modify the control signal based on the feedback signal.

8. The backlight unit of claim 7, wherein the feedback signal indicates that the calculated brightness of a first light source unit is not within a predetermined range of a target value, the control signal is modified to change the brightness of one or more neighboring light source units of the first light source unit.

9. A display device comprising:
a backlight unit for a display device comprising:
a plurality of light source units arranged in a matrix form;
a light source controller adapted to supply a control signal for controlling a brightness of the light source units; and
a plurality of light source drive units adapted to supply different driving signals to different light source units based on the control signal,
wherein the control signal is generated based on optical crosstalk between neighboring light source units;
characterized in that said control signal is determined in at least two steps, wherein in one step the control signal of one or more neighboring light source units is modified using an error spread function to compensate for local light shortage or local light surplus of the light source units.

10. A control method for a backlight unit comprising a plurality of light source units arranged in a matrix form, wherein the method comprises the steps of:
generating a control signal for controlling a brightness of the light source units; and
supplying different driving signals to different light source units based on the control signal,
wherein the control signal is generated based on optical crosstalk between neighboring light source units;
characterized in that said control signal is determined in at least two steps, wherein in one step the control signal of one or more neighboring light source units is modified using an error spread function to compensate for local light shortage and/or local light surplus of the light source units.

11. The method of claim 10, wherein the steps of generating the control signal comprises using a histogram-based video-data analysis, using a higher spatial resolution than the light source units resolution.

12. The method of claim 11, wherein the step of generating the control signal comprises using spatial high pass filtering so as to compensate for a low pass characteristic of optical crosstalk between neighboring light source units.

13. The method of claim 12, further comprising:
calculating the backlight brightness at the position of the subsegments;
providing a feedback signal to the controller (125) based on the calculated brightness; and
modifying the control signal based on the feedback signal.

14. A computer program product, comprising a computer usable medium having a computer readable program code embodied therein, said computer readable program code adapted to be executed to implement a method for controlling a backlight unit comprising a plurality of light source units arranged in a matrix form, said method comprising:
generating a control signal for controlling a brightness of the light source units; and
supplying different driving signals to different light source units based on the control signal,
wherein the control signal is generated based on optical crosstalk between neighboring light source units;
characterized in that said control signal is determined in at least two steps, wherein in one step the control signal of one or more neighboring light source units is modified using an error spread function to compensate for local light shortage and/or local light surplus of the light source units.

15. A computer program product as claimed in claim 14 wherein the method further comprises:
calculating the backlight brightness at the position of the subsegments;
providing a feedback signal to the controller based on the calculated brightness; and
modifying the control signal based on the feedback signal.
